(19) United States
(12) Patent Application Publication
(10) Pub. No.: US 2005/0204186 A1
(43) Pub. Date: Sep. 15, 2005

(54) System and method to implement a rollback mechanism for a data storage unit

(76) Inventors: Michael A. Rothman, Puyallup, WA (US); Vincent J. Zimmer, Federal Way, WA (US)

Correspondence Address: Cory G. Claassen;BLAKELY, SOKOLOFF, TAYLOR & ZAFMAN LLP, 12400 Wilshire Boulevard, Seventh Floor, Los Angeles, CA, 90025, US

(21) Appl. No.: 10/796,494

(22) Filed: Mar. 9, 2004

(51) Int. Cl. G06F 11/00

(52) U.S. Cl. 714/7

(57) ABSTRACT

A system and method to implement a rollback mechanism for a data storage unit (“DSU”). A request to write new data to a write location on the DSU is intercepted. In one technique, a copy of the old data currently residing at the write location on the DSU is saved to enable restoration of the old data to the write location on the DSU. The new data is subsequently written to the write location on the DSU. In another technique, the new data is saved to a second location different from the write location and the old data currently stored at the write location is preserved to enable rollback of the DSU to a previous state.

### TECHNICAL FIELD

This disclosure relates generally to computer systems, and in particular but not exclusively, relates to recovering from computer system failures due to erroneous or corrupted data.

### BACKGROUND INFORMATION

Computers have become a ubiquitous tool in the home and at the office. As such, the users of these tools have become increasingly reliant upon the tasks they perform. When a computer encounters a fatal system error, from which a recovery is not attainable, valuable time and data may be lost. A failed computer may result in a costly disruption in the workplace and the in ability to access data, email, and the like saved on a storage disk of the failed computer.

Computers contain many data and system files that are sensitive to manipulation and/or corruption. For example, a system registry is a configuration database in 32-bit versions of the Windows operating system (“OS”) that contains configurations for hardware and software installed on the computer. The system registry may include a SYSTEM.DAT and a USER.DAT file. Entries are added and modified as software is installed on the computer and may even be directly edited by a knowledgeable user of the computer. A computer with many applications and in use for a substantial period of time can easily contain over a hundred thousand registry entries.

An erroneous edit to an existing registry entry or addition of a corrupt, faulty, or malicious registry entry can render the entire computer impotent—incapable of booting. Tools are available on the market for performing system recoveries, such as the Windows XP Automated System Recovery (“ASR”). ASR is a two-part system recovery including ASR backup and ASR restore. ASR backup backs up the system state, system services, and all disks associated with the OS components. The ASR recovery restores the disk signatures, volumes, and partitions. However, in some situations ASR may not be capable of a complete recovery.

Another possible solution is to maintain a database of binary snapshots of a storage disk at set intervals. However, these binary snapshots can consume vast amounts of storage space. Furthermore, depending upon the snapshot interval, valuable data input since the last binary snapshot will still be lost.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a processing system to enable rollback of a data storage unit to a previous state, in accordance with an embodiment of the present invention.

FIG. 2 is a block diagram illustrating a software environment to enable rollback of a data storage unit to a previous state, in accordance with an embodiment of the present invention.

FIG. 3 is a block diagram illustrating a data storage unit capable of rolling back to a previous state, in accordance with an embodiment of the present invention.

FIG. 4 is a flow chart illustrating a process to save old data to a reserved area to enable rollback of a data storage unit to a previous state, in accordance with an embodiment of the present invention.

FIG. 5 is a diagram illustrating how old data is saved to a reserved area of a data storage unit to enable rollback to a previous state, in accordance with an embodiment of the present invention.

FIG. 6 is a flow chart illustrating another process to save old data and to provide access to new data while enabling rollback of a data storage unit to a previous state, in accordance with an embodiment of the present invention.

FIG. 7 is a diagram illustrating how old data and new data are saved to enable rollback of a data storage unit to a previous state, in accordance with an embodiment of the present invention.

FIG. 8 is a flow chart illustrating a process to recover from a system error by rolling back a data storage unit to a previous state, in accordance with an embodiment of the present invention.

FIG. 9 is a diagram illustrating a demonstrative processing system to implement rollback of a data storage unit to a previous state, in accordance with an embodiment of the present invention.

### DETAILED DESCRIPTION

Embodiments of a system and method for enabling rollback of a data storage unit to a previous good state are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In short, embodiments of the present invention preserve old data currently residing on a data storage unit (“DSU”) when new data is intended to overwrite the old data. Preservation of the old data enables the old data to be restored thereby enabling a rollback mechanism in the event of corruption of the DSU or loss of valuable data. In one embodiment, old data currently residing at a write location is backed up to a reserved area prior to writing the new data to the write location. In one embodiment, a request to write new data to a write location is diverted to the reserved area, thereby preserving the old data at the original write location in case an event requires restoration of the old data. These and other embodiments are described in detail below.

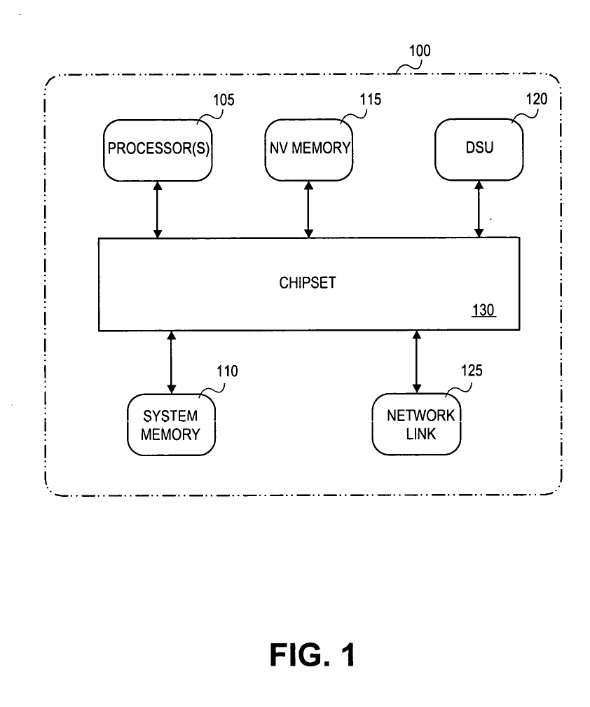

FIG. 1 is a block diagram illustrating a processing system 100 for enabling a rollback mechanism of a DSU to a previous state, in accordance with an embodiment of the present invention. The illustrated embodiment of processing system 100 includes one or more processors (or central processing units) 105, system memory 110, nonvolatile (“NV”) memory 115, a DSU 120, a network link 125, and a chipset 130. The illustrated processing system 100 may represent any computing system including a desktop computer, a notebook computer, a workstation, a handheld computer, a server, a blade server, or the like.

The elements of processing system 100 are interconnected as follows. Processor(s) 105 is communicatively coupled to system memory 110, NV memory 115, DSU 120, and network link 125, via chipset 130 to send and to receive instructions or data thereto/therefrom. In one embodiment, NV memory 115 is a flash memory device. In other embodiments, NV memory 115 includes any one of read only memory (“ROM”), programmable ROM, erasable programmable ROM, electrically erasable programmable ROM, or the like. In one embodiment, system memory 110 includes random access memory (“RAM”). DSU 120 represents any storage device for software data, applications, and/or operating systems, but will most typically be a nonvolatile storage device. DSU 120 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like. Although DSU 120 is illustrated as internal to processing system 100, DSU 120 may be externally coupled to processing system 100. Network link 125 may couple processing system 100 to a network such that processing system 100 may communicate over the network with one or more other computers. Network link 125 may include a modem, an Ethernet card, Universal Serial Bus (“USB”) port, a wireless network interface card, or the like.

It should be appreciated that various other elements of processing system 100 have been excluded from FIG. 1 and this discussion for the purposes of clarity. For example, processing system 100 may further include a graphics card, additional DSUs, other persistent data storage devices (e.g., tape drive), and the like. Chipset 130 may also include a system bus and various other data buses for interconnecting subcomponents, such as a memory controller hub and an input/output (“I/O”) controller hub, as well as, include data buses (e.g., peripheral component interconnect bus) for connecting peripheral devices to chipset 130. Correspondingly, processing system 100 may operate without one or more of the elements illustrated. For example, processing system 100 need not include network link 125.

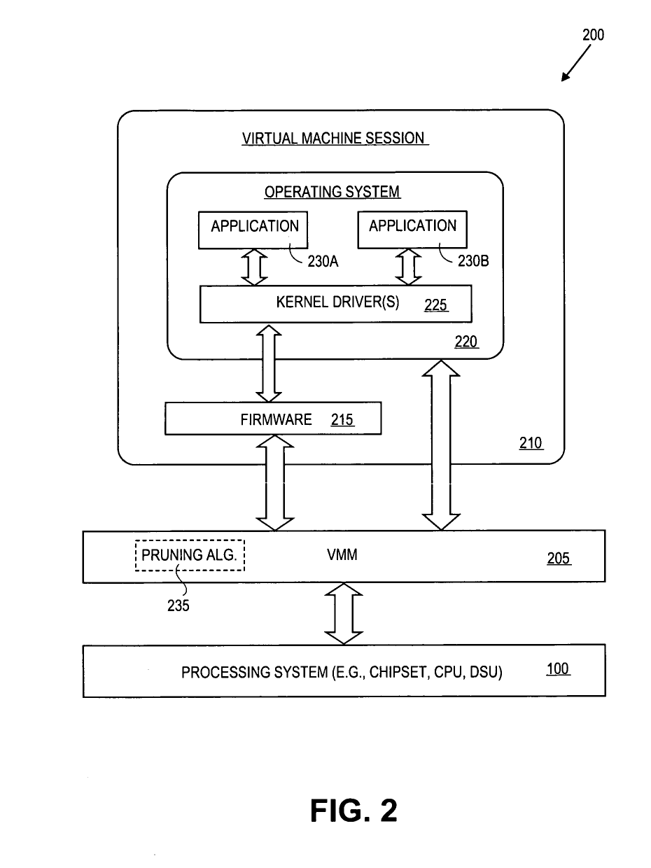

FIG. 2 is a block diagram illustrating a software environment 200 for implementing the rollback mechanism to return DSU 120 to a previously known good state, in accordance with an embodiment of the present invention. Software environment 200 is executed on processing system 100. The illustrated embodiment of software environment 200 includes a virtual machine monitor (“VMM”) 205, a virtual machine (“VM”) session 210, firmware 215, and an operating system (“OS”) 220. In the illustrated embodiment, OS 220 includes kernel driver(s) 225 and OS 220 may support one or more applications 230A and 230B (collectively referred to as applications 230). The illustrated embodiment of VMM 205 may include a pruning algorithm 235.

The elements of software environment 200 and processing system 100 interact as follows. VMM 205 operates to coordinate execution of VM session 210. VM session 210 behaves like a complete physical machine, and OS 220 and applications 230 are typically unaware that they are being executed with VM session 210. In one embodiment, VMM 205 is firmware layered on top of processing system 100. VMM 205 provides a software layer to enable operation of VM session 210. In general, VMM 205 acts as an proxy between VM session 210 (and therefore OS 220 and firmware 215) and the underlying hardware of processing system 100. VMM 205 can allocate system resources of processing system 100 to VM session 210, including one or more of system memory 110, address space, input/output bandwidth, processor runtime (e.g., time slicing if multiple VM sessions are executed on processing system 100 at a given time), and storage space of DSU 120. As such, VMM 205 is capable of hiding portions of the system resources from OS 220 and applications 230 and even consuming portions of these system resources (e.g., processor runtime, system memory 110, and storage space of DSU 120), entirely unbeknownst to OS 220 and applications 230.

In one embodiment, VMM 205 is a firmware driver executing within an extensible firmware framework standard known as the Extensible Firmware Interface (“EFI”) (specifications and examples of which may be found at http://www.intel.com/technology/efi). EFI is a public industry specification that describes an abstract programmatic interface between platform firmware and shrink-wrap operating systems or other custom application environments. The EFI framework standard includes provisions for extending basic input output system (“BIOS”) code functionality beyond that provided by the BIOS code stored in a platform's boot firmware device (e.g., NV memory 115). More particularly, EFI enables firmware, in the form of firmware modules and drivers, to be loaded from a variety of different resources, including primary and secondary flash devices, ROMs, various persistent storage devices (e.g., hard disks, CD ROMs, etc.), and even over computer networks.

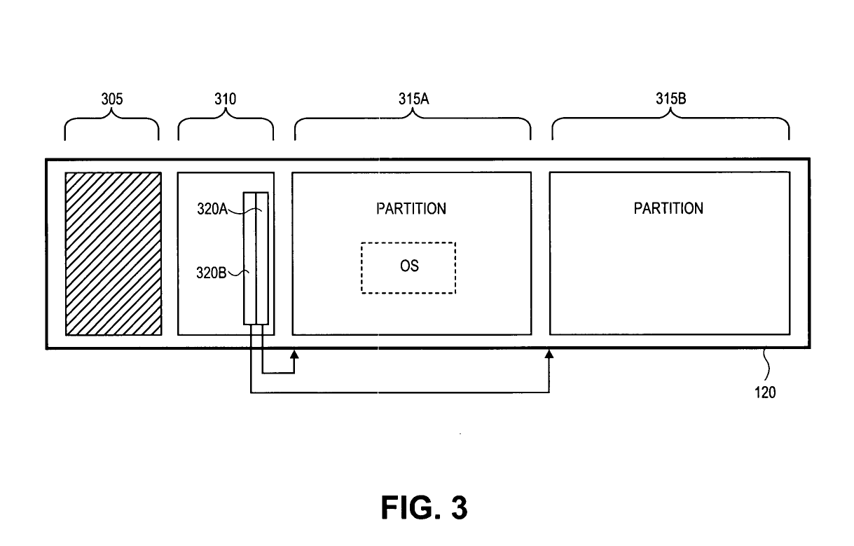

FIG. 3 is a block diagram illustrating DSU 120 having content stored thereon, in accordance with an embodiment of the present invention. The illustrated embodiment of DSU 120 includes a reserved area 305, a partition table 310, and two partitions 315A and 315B (collectively referred to as partitions 315). Partition table 310 includes two partition pointers 320A and 320B pointing to boot targets of partitions 315A and 315B, respectively. It should be appreciated that two partitions are illustrated for explanation only and more or less partitions may be present on DSU 120.

Partitions 315 may each include their own OS, applications and data. Alternatively, partition 315A may contain OS 220 (as illustrated) while partition 315B may contain data and/or applications only. In one embodiment, partition table 310 includes a master boot record, in the case of a legacy type processing system, or a globally unique identifier (“GUID”) partition table (“GPT”), in the case of an EFI based processing system. In one embodiment, reserved area 305 is a portion of DSU 120 reserved for use by VMM 205 and hidden from OS 220 when executing. VMM 205 hides reserved area 305 from VM session 210 and OS 220. In one embodiment, VMM 205 excludes reserved area 305 from a an address map or list of resources that it allocates and provides to VM session 210 and OS 220. Thus, in one embodiment, only VMM 205 is aware of and has access to reserved area 305. Therefore, errant or malicious programs executing within VM session 210 cannot write into reserved area 305 as only VMM 205 is aware of and has access to reserved area 305.

It is to be appreciated that the diagram of DSU 120 illustrated in FIG. 3 is merely illustrative and is not necessarily drawn to scale. For example, partition table 310 may have been exaggerated in comparison to partitions 315. Similarly, reserved area 305 may consume a larger or smaller portion of DSU 120 than illustrated. Although reserved area 305 is illustrated as included within DSU 120, reserved area 305 need not be allocated on DSU 120, but rather can be allocated on a separate data storage unit from DSU 120.

The processes explained below are described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like.

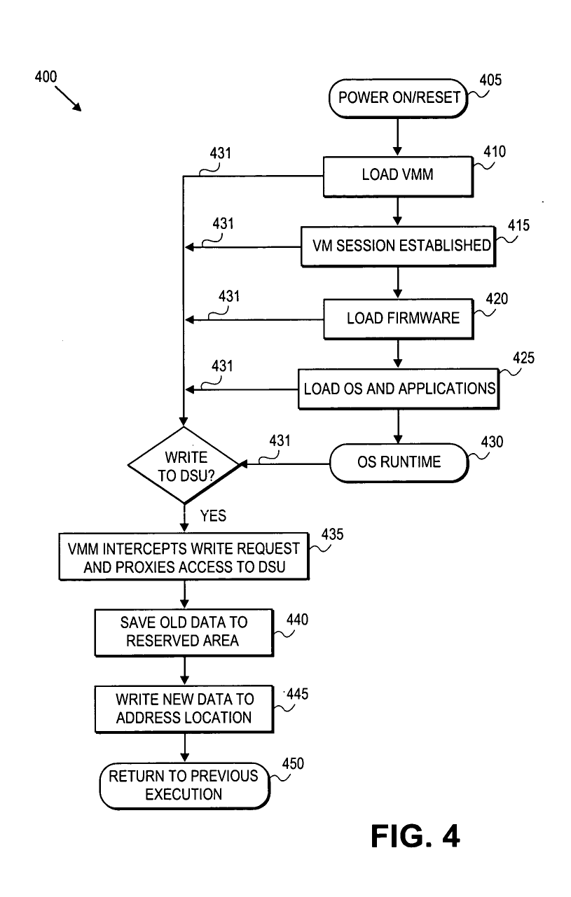

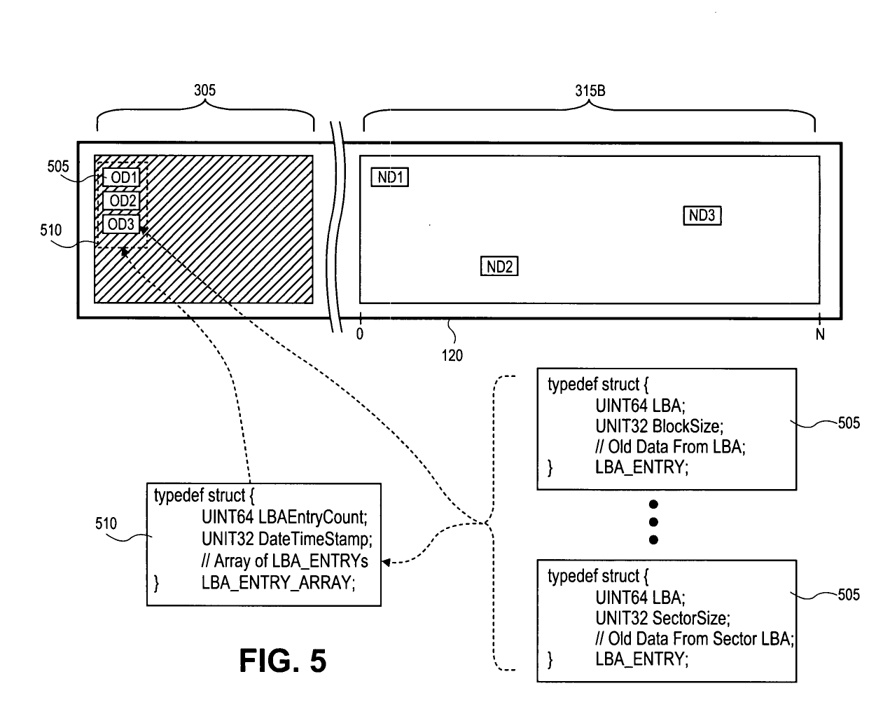

FIG. 4 is a flow chart illustrating a process 400 for preserving old data currently stored on DSU 120 thereby enabling a rollback of DSU 120 to a previous state, in accordance with an embodiment of the present invention. Process 400 is described with reference to FIG. 5. FIG. 5 illustrates a portion of DSU 120.

In a process block 405, processing system 100 is powered on, power cycled, or otherwise reset. Next, in a process block 410, processing system 100 loads VMM 205 into system memory 110 for execution by processor 105. In one embodiment, VMM 205 is initially stored within NV memory 115. In other embodiments, VMM 205 may be loaded from any number of internal or attached storage devices, including DSU 120. Once executing, VMM 205 can begin to act as a proxy agent to DSU 120. In other words, all writes to and all read from DSU 120 are proxied through VMM 205. When a request is made to write to DSU 120, VMM 205 intercepts the request (a.k.a. trapping the request) and executes the write operation as described below. When a request is made to read from DSU 120, VMM 205 intercepts or traps the request and executes the read operation.

Once VMM 205 has been loaded, VM session 210 is established in a process block 415. When establishing VM session 210, VMM 205 allocates system resources to VM session 210. In one embodiment, VMM 205 provides VM session 210 with an address map, which does not include reserved area 305. In process blocks 420 and 425, firmware 215, OS 220, and applications 230 are loaded into VM session 220. These loads may execute as they typically would. Firmware 215 may be legacy firmware, EFI firmware, or otherwise for interfacing with hardware of processing system 100. However, in the illustrated embodiment, firmware 215 does not directly interface with hardware, but rather does so unwittingly by proxy through VMM 205. Similarly, OS 220 and applications 230 are unaware that they are being loaded into VM session 210 or that their access to hardware of processing system 100 is proxied by VMM 205.

Once OS 220 has been loaded in process block 425, processing system 100 enters an OS runtime in a process block 430. As illustrated by flow paths 431, anytime after VMM 205 has been loaded, it can proxy access to DSU 120, whether that access be by firmware 215 in process block 420 or one of applications 230 executing during OS runtime in process block 430. In one embodiment, VMM 205 intercepts and proxies both write operations and read operations. In one embodiment, VMM 205 only intercepts and proxies write operations. If an entity executing within VM session 210 attempts to write to DSU 120, process 400 continues to a process block 435.

In process block 435, upon issuance of the request to write to DSU 120, VMM 205 intercepts the write request and proxies access to DSU 120. This request to write to DSU 120 may originate, for example, from application 230B or from the installation of an update to application 230B. Prior to writing the new data to the write location on DSU 120 specified by application 230B or an install wizard, VMM 205 saves a copy of the data currently residing at the write location, in a process block 440. The old data is saved to reserved area 305. In a process block 445, VMM 205 then writes the new data to the write location. In a process block 450, process 400 returns to one of process blocks 410 to 430 based on where the write request was issued from.

For illustration, FIG. 5 depicts old data OD1, OD2, and OD3 currently stored within reserved area 305. Old data OD1, OD2, and OD3 correspond to new data ND1, ND2, and ND3, respectively, which has been written to various locations within partition 315B of DSU 120. In other words, prior to writing the new data to the various write location within partition 315B, the old data was copied from these write locations to reserved area 305. The old data may be saved to reserved area 305 using any number of recordation schemes, which enable restoration of the old data to their respective source locations in one of partitions 315, should DSU 120 become corrupt, unstable, or it is otherwise desirable to rollback DSU 120 to a previous state. In one embodiment, old data OD1, OD2, and OD3 may be saved to reserved area 305 along with information pertinent to facilitate its restoration. For example, the old data may be saved along with the addresses of their source locations (i.e., the write locations) and the unit size of the old data being saved (i.e., the unit sizes of the new data to overwrite the write locations).

The source location saved along with the old data may include anyone of a sector address, a cluster address, a logical block address (“LBA”), or the like. The unit size may simply be the number of sectors, the number of clusters, the number of LBA's, the number of bytes, or the like. FIG. 5 illustrates one possible embodiment using LBA's. Data structures 505 each include an LBA, a BlockSize, and the old data itself. The LBA references the source address from where the old data was copied (i.e., the write location). The block size represents the number of bytes making up the old data.

Each data structure 505 may be generated for each of old data OD1, OD2, and OD3. For example, if new data ND1, ND2, and ND3 represent the portions or sectors of DSU 120 that were overwritten during an installation of an update to application 230B, prior to writing the new data VMM 205 would generate a corresponding data structure 505 for each of old data OD1, OD2, and OD3 and save the data structure 505 to reserved area 305.

Data structures 505 may further be grouped together in a data structure array (“DSA”) 510. DSA 510 includes one or more data structures 505, a time marker, and a count of the number of data structures 505 associated together within the DSA 510. The DSA 510 is a structure used to associate all changes to DSU 120 after a given data and time. The timer marker could be a marker set at a last known good state of DSU 120. A last known good state could be immediately following a successful boot of processing system 100 or immediately following a factory install of software on DSU 120. Alternatively, a user of processing system 100 could manually set the time marker via a graphical user interface or a series of keystrokes (e.g., user defined keystrokes). Once the time marker (e.g., date and time stamp) is set, all changes subsequent to that time marker are associated together within DSA 510 to enable rollback of DSU 120 to the specified data and time.

Since DSA 510 is an array of old data that would have been overwritten rather than entire previous versions of updated software on DSU 120, DSA 510 is referred to as a sparse array. Reserved area 305 does not contain complete programs, but rather only the old portions of programs (e.g., OS 220, applications 230) that have been updated or otherwise changed. Therefore, using a sparse array of changed or overwritten locations on DSU 120 saves storage space compared to saving entire previous versions of updated software.

It should be appreciated that multiple time markers or date and time stamps may be set providing a user of processing system 100 with the option to rolling back DSU 120 to one of several previously known good states. In an alternative embodiment, each individual data structure 505 may include its own date and time stamp, as opposed to grouping multiple data structures 505 together.

In yet another embodiment, the time marker may simply be a whole number representing a rollback tier. Each rollback tier may correspond to a boot cycle and multiple tiers of old data may be stored within reserved area 305 at a given time. For example, if a user boots processing system 100 each morning through out a work week, reserved area 305 may contain five rollback tiers enabling a user to roll DSU 120 back to its exact state at the completion of each daily boot. A pruning algorithm 235 (illustrated in FIG. 2) could be implemented to delete all old data that is more than five tiers old. The number of rollback tiers need not be 5, but more or less depending upon the space available on DSU 120 and the amount of space the user is willing to devote to the rollback functionality described herein.

One of ordinary skill in the art having the benefit of the instant disclosure will recognize that many organizations, data structures, and techniques may be implemented within the scope of the present invention to save old data OD1, OD2, and OD3 to reserved area 305. Furthermore, many techniques may be implemented for time stamping the old data and providing a multi-state rollback functionality.

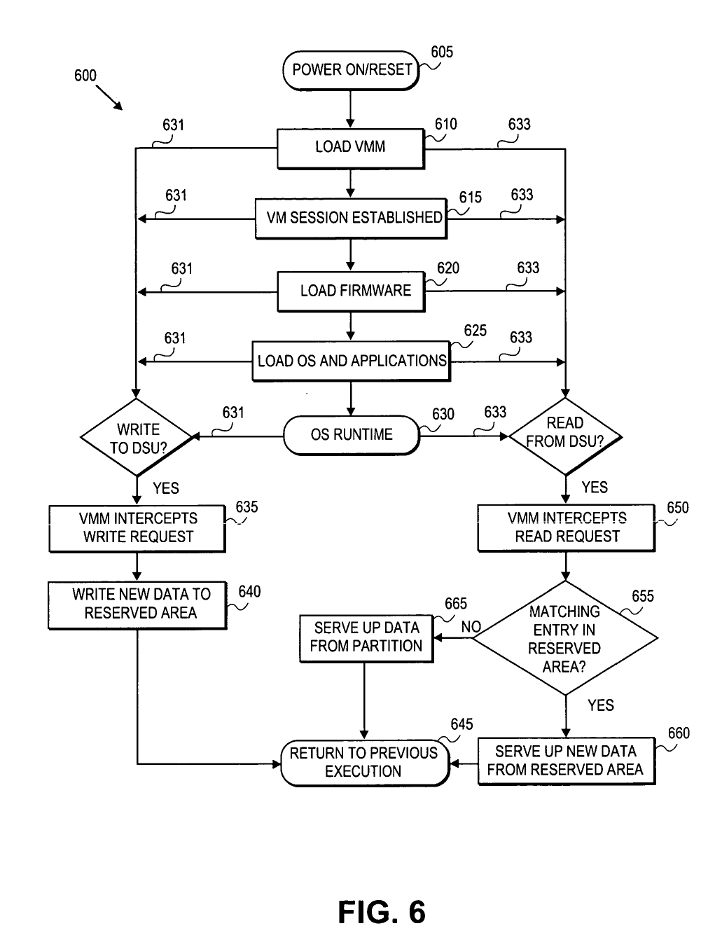

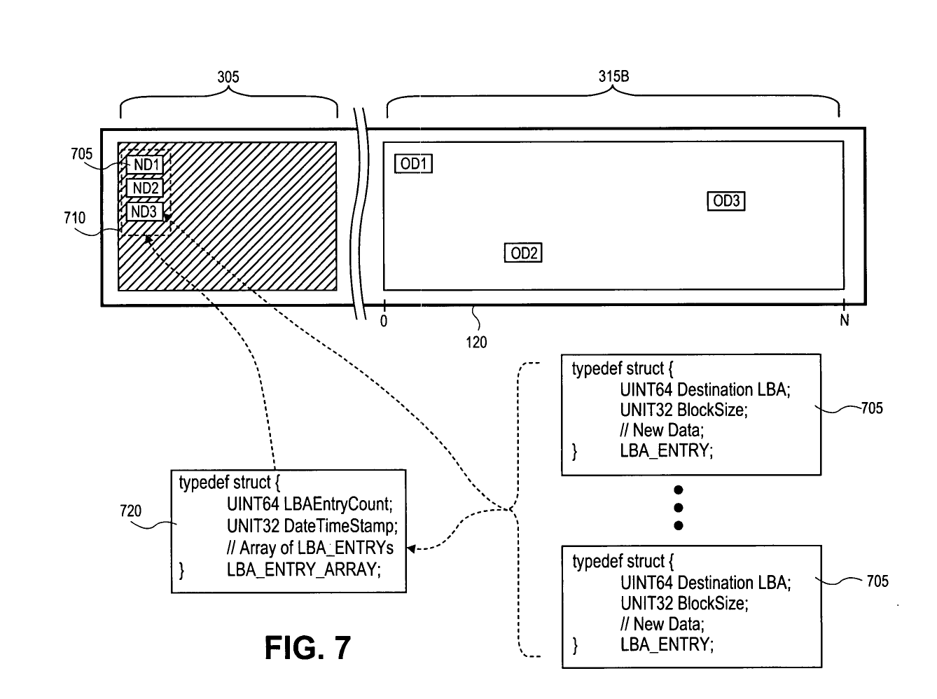

FIG. 6 is a flow chart illustrating a process 600. Process 600 is yet another technique for preserving data currently stored on DSU 120 and designated to be overwritten, thereby enabling a rollback mechanism for DSU 120, in accordance with an embodiment of the present invention. Process 600 is described with reference to FIG. 7. As can be seen in FIG. 7, new data ND1, ND2, and ND3 is saved to reserved area 305, while old data OD1, OD2, and OD3 remains within partition 315B. In this embodiment, reserved area 305 contains a sparse array of updates and/or new data.

Process blocks 605 through 630 are similar to process blocks 405 through 430 of process 400, respectively. At anytime after loading VMM 205 (process block 610) up to and including execution within the OS runtime (process block 630), a request to read from or write to DSU 120 may be issued. If a request to write to DSU 120 is issued, process 600 continues along flow paths 631 to a process block 635.

In process block 635, VMM 205 intercepts the write request. As discussed above, in one embodiment, all write requests are trapped to VMM 205. In a process block 640, the new data (e.g., new data ND1, ND2, or ND3) is written to reserved area 305, as illustrated in FIG. 7, instead of the write location within partitions 315 and requested by an application, OS 220, or other entity desiring to write to DSU 120. Thus, VMM 205 diverts all writes directed towards partition 315B to reserved area 305 instead. In so doing, the old data currently saved at the write location (e.g., old data ND1, ND2, and ND3) is left untouched or preserved for future use or to enable rollback of DSU 120 to a previous state in the event of a subsequent corruption of DSU 120. In one embodiment, when writing the new data to reserved area 305 VMM 205 saves the new data along with the original write location (or write address). The write location could be any of a sector address, a cluster address, an LBA, or the like. In one embodiment, the new data is further saved along with a value indicating the block size of the new data diverted to reserved area 305.

Data structures 705 are example data structures using LBA's for saving the new data to reserved area 305. In one embodiment, the data structures 705 may further be grouped together and time and data stamped. DSA 710 illustrates an example data structure for associating multiple writes of new data to reserved area 305. Data DSA 710 includes an array of data structures 705 along with a group time marker (e.g., date and time stamp) and a value indicating the number of data structures 705 being associated together. In one embodiment, data structures 705 and DSA 710 are similar to data structures 505 and DSA 510.

After the new data is written to reserved area 305, process 600 returns to the one of process blocks 610-630 from where the write request was issued (process block 645). If on the other hand a request to read from DSU 120 is issued, process 600 continues from one of process blocks 610-630 along flow paths 633 to a process block 650. In process block 650, VMM 205 traps or intercepts the read request. In a decision block 655, VMM 205 determines whether the read location on partition 315B address by the read request has a corresponding update or new data within reserved area 305. If new data corresponding to the read location does exist, then VMM 205 serves up or provides the requester with the corresponding new data from reserved area 305, instead of the old data residing at the actual read location within partition 315B (process block 660). In one embodiment, the requester (e.g., OS 220, applications 230, kernel driver(s) 225, firmware 215, etc.) for the data residing at a read address within partition 315B is completely unaware that VMM 205 has diverted the read request to reserved area 305.

In one embodiment, VMM 205 is capable of determining whether corresponding new data exists within reserved area 305 by comparing the read address provided by the requester against the write address stored along with each data structure 705 containing the new data (e.g., new data ND1, ND2, and ND3). Furthermore, if multiple tiers of updates have been stored to reserved area 305, VMM 205 will provide the new data having a matching write address and having the most recent time marker or time and data stamp. Once the new data has been provided to the requester, process 600 returns to the one of process blocks 610-630 from where the request was issued (process block 645).

Returning to decision block 655, if new data corresponding to the requested read location does not exist within reserved area 305, then VMM 205 determines that no updates or changes have been made to the requested read location of partition 315B. In this case, process 600 continues to a process block 665 where VMM 205 serves up the data currently residing at the requested read location within partition 315B. Once the requested data is provided to the requester, process 600 returns to the one of process blocks 610-630 from where the read request was issued (process block 645).

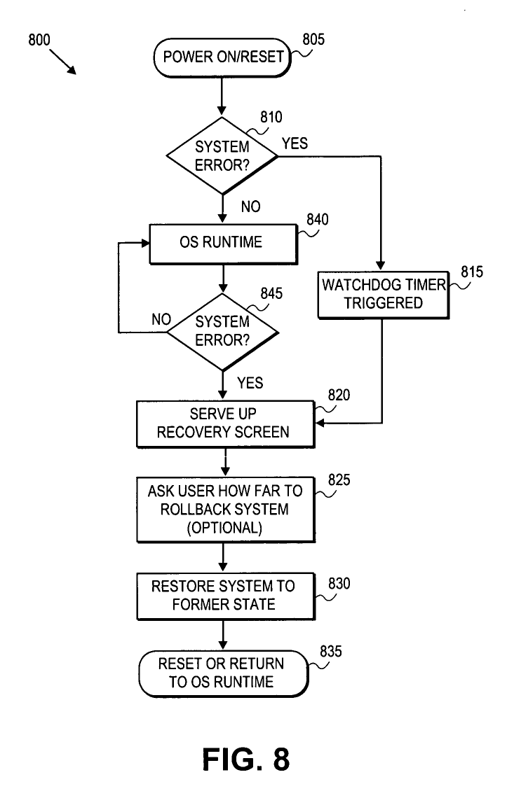

FIG. 8 is a flow chart illustrating a process 800 to rollback DSU 120 to a previous state once a system error has occurred, in accordance with an embodiment of the present invention. The techniques described herein are capable of rolling back DSU 120 from either a pre-boot runtime or an OS runtime. Thus, if DSU 120 is so corrupted that processing system 100 cannot be booted, the present techniques may be used to rollback DSU 120 to a previous known good state. Furthermore, it should be appreciated that these techniques are not limited to use only when a fatal error has occurred, rather they may be implemented anytime a user of processing system 100 desires to return to a previous state. An example may include when the user has irretrievably deleted data that he/she desires to recover.

In a process block 805, processing system 100 is turned on or otherwise reset. If an erroneous or malicious write to DSU 120 occurred during a previous use session of processing system 100, then a system error may occur during the boot-up phase of processing system 100. If a system error does occur and processing system 100 is incapable of booting (decision block 810), then the processing system may hang and/or splash an error message to the screen. In one embodiment, after a finite period of idle time, a watchdog timer may be triggered, in process block 815, if a specified event does not reset the watchdog timer prior to expiration of the finite period. The reset event may occur once processing system 100 has completed critical steps of the boot-up process or after the boot-up process is complete and OS runtime has commenced. In any event, if processing system 100 has hung during the boot-up phase and the reset event does not occur, the watchdog time will be triggered and process 800 continues to a process block 820.

In process block 820, a recovery screen is displayed to the user of processing system 100. The recovery screen may be a simple text message or a graphical user interface. The recovery screen may be generated within a management mode of operation of processing system 100. In one embodiment, the watchdog timer triggers processing system 100 to entering a management mode of operation, such as System Management Mode (“SMM”), from where the recovery screen is served up. SMM is specified by an IA-32 Intel Architecture Software Developer's Manual, Volume 3: System Programming Guide (2003) made available by Intel® Corporation. Since the 386SL processor was introduced by the Intel® Corporation, SMM has been available on 32-bit Intel Architecture (“IA-32”) processors as an operation mode hidden to operating systems that executes code loaded by firmware. SMM is a special-purpose operating mode provided for handling system-wide functions like power management, system hardware control, or proprietary original equipment manufacturer (“OEM”) designed code. The mode is deemed transparent or “hidden” because pre-boot applications, OS 220, and OS runtime software applications (e.g., applications 230) cannot see it, or even access it. SMM is accessed upon receipt of a system management interrupt (“SMI”) 150, which in one embodiment may be triggered by the watchdog timer.

The recovery screen may optionally include choices for the user to select how far back to rollback DSU 120, if multiple tiers of old data have been preserved (process block 825). In a process block 830, the old data preempted by the new data is restored to return DSU 120 to a previously good state.

Referring to the embodiment depicted in FIG. 5, restoring the old data back to their source locations within partition 315B executes the rollback mechanism. Since the old data is saved with its original source location (e.g., LBA of data structures 505), VMM 205 can determine the precise locations within partition 315B to restore the old data. The new data, which was the result of an erroneous, corrupt, or malicious write is overwritten to restore processing system 100 to a healthy state.

Referring to the embodiment depicted in FIG. 7, DSU 120 is restored to its previous state simply by erasing the new data (e.g., new data ND1, ND2, and ND3) from reserved area 305. Again, embodiments of the present invention may enable rollback to various previous known good states. Thus, rollback to different states may be executed simply by deleting all new data within reserved area 305 having a time marker after a specified time and date. Once the new data is erased, VMM 205 will determine that no entry within reserved area 305 corresponds to the requested read location (see decision block 655 of FIG. 6), and therefore, VMM 205 will serve up the old data (e.g., old data OD1, OD2, and OD3) residing within partition 315B, or VMM 205 will serve up new data with an older time marker.

Returning to FIG. 8, once DSU 120 has been restored, processing system 100 may either be reset or commence execution from where it was interrupted due to the system error (process block 835). Returning to decision block 810, if processing system 100 boots without error, processing system 100 will commence execution within the OS runtime (process block 840). Should an error occur during the OS runtime (decision block 845), the recovery screen may be displayed in process block 820 and process 800 continues therefrom as described above.

It should be appreciated that recovery from a system error need not require input from the user. For example, if processing system 100 is hopelessly hung or crashed, process 800 may be modified such that DSU 120 is automatically rolled back to the last known good state. Whether or not rollback of DSU 120 is manually executed or automated may be a user-defined policy. Alternatively, a user need not wait for processing system 100 to hang or otherwise experience a system error to rollback the state of DSU 120. Rather, the user may access the rollback mechanism during OS runtime via an application or a series of user defined keyboard strokes to rollback DSU 120 as desired.

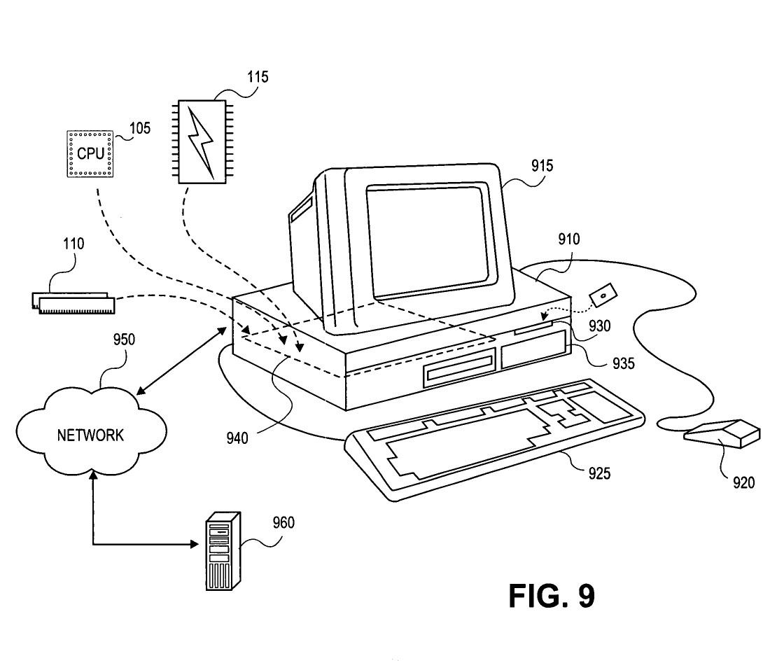

FIG. 9 is a diagram of a system 900 including an isometric view of a processing system 905, in accordance with an embodiment of the present invention. Processing system 905 is one possible embodiment of processing system 100. The illustrated embodiment of processing system 905 includes a chassis 910, a monitor 915, a mouse 920 (or other pointing device), and a keyboard 925. The illustrated embodiment of chassis 910 further includes a floppy disk drive 930, a hard disk 935 (e.g., DSU 120), a compact disc (“CD”)and/or digital video disc (“DVD”) drive 937, a power supply (not shown), and a motherboard 940 populated with appropriate integrated circuits including system memory 110, NV memory 115, and one or more processors 105.

In one embodiment, a network interface card (“NIC”) (not shown) is coupled to an expansion slot (not shown) of motherboard 940. The NIC is for connecting processing system 905 to a network 950, such as a local area network, wide area network, or the Internet. In one embodiment network 950 is further coupled to a remote computer 960, such that processing system 905 and remote computer 960 can communicate.

Hard disk 935 may comprise a single unit, or multiple units, and may optionally reside outside of nrocessing system 905. Monitor 915 is included for displaying graphics and text generated by software and firmware programs run by processing system 905. Mouse 920 (or other pointing device) may be connected to a serial port, a universal serial bus port, or other like bus port communicatively coupled to processor(s) 105. Keyboard 925 is communicatively coupled to motherboard 940 via a keyboard controller or other manner similar to mouse 920 for user entry of text and commands.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
intercepting a request to write new data to a location on a data storage unit (“DSU”);
saving a copy of old data currently residing at the location on the DSU to enable restoration of the old data to the location on the DSU; and
writing the new data to the location on the DSU.

2. The method of claim 1, further comprising restoring the old data to the location using the saved copy of the old data to rollback the DSU to a previous state.

3. The method of claim 2, further comprising:
generating a recovery screen asking a user whether to restore the previous state in response to encountering a system error.

4. The method of claim 2, wherein saving the copy of the old data further comprises saving the copy of the old data with a time marker to enable rollback of the DSU to a known good state.

5. The method of claim 4, further comprising:
saving multiple versions of the old data correlated with time markers to enable rollback of the DSU to one of multiple previous states.

6. The method of claim 5, further comprising:
pruning versions of the old data having an expired time marker.

7. The method of claim 2, wherein saving the copy of the old data comprises saving the copy to a reserved area of the DSU hidden from an operating system (“OS”).

8. The method of claim 6, further comprising:
executing the OS within a virtual machine; and
proxying access to the DSU with a virtual machine monitor (“VMM”), wherein the VMM intercepts the request to write the new data and saves the copy of the old data to the reserved area.

9. A method, comprising:
intercepting a request to write new data to a first location on a data storage unit (“DSU”);
saving the new data to a second location different from the first location; and
leaving old data currently stored at the first location to enable rollback of the DSU to a previous state.

10. The method of claim 9, further comprising
intercepting a request to read the first location of the DSU;
determining whether the new data corresponding to the first location is currently saved at the second location; and
diverting the request to read the first location to the second location.

11. The method of claim 10, wherein saving the new data to the second location further comprises saving an address of the first location along with the new data at the second location.

12. The method of claim 11, wherein the second location is located within a reserved area of the DSU hidden from an operating system loaded from a partition of the DSU.

13. The method of claim 12, wherein determining whether the new data corresponding to the first location is currently saved at the second location comprises searching the reserved area for a match between a read address of the request to read the first location and the address of the first location saved along with the new data at the second location.

14. The method of claim 9, further comprising rolling back the DSU to the previous state by:
deleting the new data written to the second location; and
directing the request to read the first location to the first location.

15. A machine-accessible medium that provides instructions that, if executed by a machine, will cause the machine to perform operations comprising:
intercepting a request to write new data to a location on a data storage unit (“DSU”);
saving a copy of old data currently residing at the location on the DSU to enable restoration of the old data to the location on the DSU; and
writing the new data to the location on the DSU.

16. The machine-accessible medium of claim 15, further providing instructions that, if executed by the machine, will cause the machine to perform further operations, comprising:
restoring the old data to the location using the saved copy of the old data to rollback the DSU to a previous state.

17. The machine-accessible medium of claim 16, wherein saving the copy of the old data further comprises saving the copy of the old data with a time stamp to enable rollback of the DSU to a known good state.

18. The machine-accessible medium of claim 17, wherein saving the copy of the old data further comprises saving the copy of the old data with an address of the location to enable restoring the old data to the location.

19. The machine-accessible medium of claim 15, further providing instructions that, if executed by the machine, will cause the machine to perform further operations, comprising:
executing an operating system (“OS”) within a virtual machine; and
proxying access to the DSU with a virtual machine monitor (“VMM”), wherein the VMM intercepts the request to write the new data and saves the copy of the old data to a reserved area hidden from the OS.

20. A machine-accessible medium that provides instructions that, if executed by a machine, will cause the machine to perform operations comprising:
intercepting requests to write new data to write locations within a first portion of a data storage unit (“DSU”);
saving the new data to a reserved area not including the first portion; and
leaving data currently stored at the write locations to enable rollback of the DSU to a previous state.

21. The machine-accessible medium of claim 20, further providing instructions that, if executed by the machine, will cause the machine to perform further operations, comprising:
intercepting a request to read a read location within the first portion;
determining whether any of the new data saved within the reserved portion corresponds to the read location; and
providing a corresponding portion of the new data in response to the request to read the read location, if some of the new data saved within the reserved area is determined to correspond to the read location.

22. The machine-accessible medium of claim 21, further providing instructions that, if executed by the machine, will cause the machine to perform further operations, comprising:
providing data saved at the read location within the first portion in response to the request to read the read location, if none of the new data saved within the reserved area is determined to correspond to the read location.

23. The machine-accessible medium of claim 22, wherein saving the new data to the reserved area further comprises saving the new data to the reserved area along with addresses of the corresponding write locations and wherein determining whether any of the new data saved within the reserved portion corresponds to the read location comprises comparing the addresses saved within the reserved area to a read address of the read location.

24. The machine-accessible medium of claim 20, further providing instructions that, if executed by the machine, will cause the machine to perform further operations, comprising
deleting the new data saved to the reserved area to rollback the DSU to a known good state.

25. A system, comprising:
a processor to execute instructions;
a hard disk drive (“HDD”) to save old data and new data; and
non-volatile memory accessible by the processor and having the instructions stored thereon, which if executed by the processor, will cause the processor to perform operations comprising:
intercepting a request to write new data to a write location on the HDD;
saving a copy of old data currently residing at the write location on the HDD to enable restoration of the old data to the write location on the HDD; and
writing the new data to the write location on the HDD.

26. The system of claim 25 wherein the non-volatile memory further includes instructions stored thereon, which if executed by the processor, will cause the processor to perform further operations comprising:
restoring the old data to the write location using the saved copy of the old data to rollback the HDD to a previous state.

27. The system of claim 25 wherein saving the copy of the old data currently residing at the write location comprises saving the copy of the old data with a time marker and an address of the write location to enable rollback of the HDD to a known good state.

28. The system of claim 27 wherein saving the copy of the old data currently residing at the write location further comprises saving the copy to a reserved area of the HDD hidden from an operating system saved on the HDD.

29. The system of claim 25 wherein the HDD comprises the non-volatile memory.

30. A system, comprising:
a processor to execute instructions;
a hard disk drive (“HDD”) to save old data and new data; and
non-volatile memory accessible by the processor and having the instructions stored thereon, which if executed by the processor, will cause the processor to perform operations comprising:
intercepting requests to write new data to write locations within a first portion of the HDD;
saving the new data to a reserved area not including the first portion; and
preserving old data currently stored at the write locations to enable rollback of the HDD to a previous state.

31. The system of claim 30 wherein the non-volatile memory further includes instructions stored thereon, which if executed by the processor, will cause the processor to perform further operations comprising:
intercepting a request to read a read location within the first portion;
determining whether any of the new data saved within the reserved portion corresponds to the read location; and
providing a corresponding portion of the new data in response to the request to read the read location, if some of the new data saved within the reserved area is determined to correspond to the read location.

32. The system of claim 31 wherein the non-volatile memory further includes instructions stored thereon, which if executed by the processor, will cause the processor to perform further operations comprising:
providing data saved at the read location within the first portion in response to the request to read the read location, if none of the new data saved within the reserved area is determined to correspond to the read location.

33. The system of claim 32 wherein the non-volatile memory further includes instructions stored thereon, which if executed by the processor, will cause the processor to perform further operations comprising:
deleting the new data saved to the reserved area to rollback the DSU to a known good state.
